(19) United States
(12) Patent Application Publication
(10) Pub. No.: US 2022/0227008 A1
(43) Pub. Date: Jul. 21, 2022

(54) MACHINE AND METHOD TO AUTOMATICALLY TRANSPORT ONE OR MORE COMPONENTS TO MAKE A PACKAGE FROM AND TO ONE OR MORE WORKING STATIONS

(71) Applicant: I.M.A. INDUSTRIA MACCHINE AUTOMATICHE S.P.A., Ozzano dell'Emilia (IT)

(72) Inventors: Mattia Chianura, Ozzano dell'Emilia (IT); Claudio Trebbi, Ozzano dell'Emilia (IT)

(21) Appl. No.: 17/622,951

(22) PCT Filed: Jun. 30, 2020
(86) PCT No.: PCT/IT2020/050165

§ 371 Date: Dec. 27, 2021

(30) Foreign Application Priority Data
Jul. 1, 2019 (IT) 102019000010536

(51) Int. Cl. B25J 15/02; B25J 9/00; B25J 5/02; B25J 18/06; B25J 9/02; B25J 9/12; B25J 13/08; B65B 3/00; B65B 43/46; B65B 43/54

(52) U.S. Cl. CPC B25J 15/0246; B25J 9/0015; B25J 5/02; B25J 18/06; B25J 9/0087; B65B 43/54; B25J 9/12; B25J 13/082; B65B 3/003; B65B 43/46; B25J 9/023

(57) ABSTRACT

A machine (10) to automatically transport, from and to one or more working stations (12), one or more components (11) to make a package, comprises a reference surface (13), with which electric energizing members (14) are associated to selectively generate one or more magnetic fields, and at least a pair of support members (15) each provided with magnetic means (16) configured to interact with the magnetic fields. The machine (10) comprises control means (17) configured to energize selectively and in a coordinated manner the electric energizing members (14) to cause the selective movement of each support member (15) from one point to another of the reference surface (13). Each support member (15) is also provided with respective gripping means (18) comprising at least one support arm (19), wherein the support arm (19) of the first support member (15) is configured to cooperate with the support arm (19) of the second support member (15) to selectively temporarily grip and support at least one or more components (11).

### FIELD OF THE INVENTION

The present invention concerns a machine and the corresponding method to automatically transport one or more components to make a package, in particular a package for a pharmaceutical product, from and to one or more working stations, in particular, but not only, components such as containers, in particular containers for products of various kinds, both fluid, and solid, or in powder or gel form, for example drugs, food, or drinks, or caps, ring nuts or other elements or components necessary to make the package as above. The working stations can comprise, although each of them does not necessarily have to be present, a storage station for empty containers and/or components in general to make the package, one or more weighing stations, a station for filling the containers, a station for closing each container and a station for packing the filled containers. The transport of each component of the package, or group of components, takes place independently, in a contactless manner, with no constraint in the direction or path and with no generation of particulate due to rubbing, for example with the use of planar motors, in a safe and clean environment, using devices and apparatuses that require human intervention that is reduced to a minimum, or close to zero.

### BACKGROUND OF THE INVENTION

In the industrial sector of the automated filling of containers, various machines and methods are known to automatically transport one or more components to make a package, in particular a package for a pharmaceutical product, from and to one or more working stations, many of which are designed, made and marketed by the present Applicant.

The components in question can be containers, caps, ring nuts or other elements or components necessary to make the package. The containers, for example, can have different shapes and sizes, from small vials for medicines, with a capacity of a few milliliters, or syringes, or Carpules®, that is, ampoules or cartridges containing liquid medication to be inserted in a syringe, to the most capacious containers, with capacities above one liter, able to contain fluid products, in particular liquids, or solids and in powder or gel form.

Known machines normally comprise a plurality of working stations, such as for example a storage station for the empty containers and/or components to make the package in general, one or more possible weighing stations for each empty container, a station for filling the containers, a station for closing each container and a station for packing or packaging the filled containers, ready for delivery, or for storage in a warehouse for finished products.

The movement of the components to make the package from one station to another is usually carried out with mechanical and motorized transport devices, or apparatuses, which comprise, for example, conveyor belts, turntables, or carousels, gears, chains, slides, lifters, mechanical arms, possibly robotic, and other mechanical members.

Examples of such known transport devices, provided with gripping members configured to transport the components, are described in the patent documents no. KR 20170033652, U.S. Pat. No. 4,132,318, JP H08197474, JP 2017012415 and JP 2001079789.

However, all known transport devices make the machine more complex, intrinsically conferring some disadvantages on it, such as the generation of noise and particulates, and therefore unwanted contamination and pollution inside the machine, requiring the need for controls, for example biological, microbiological or particulate, and the almost constant presence of human personnel to monitor and carry out interventions both in the event of malfunction during operation and also in the event of maintenance.

The technical problem that the inventors have proposed to solve is to make a machine and perfect the corresponding method to make it function, through a series of work steps, which can move the components to make the package from one working station to the other, in a safe, ecologically sustainable and silent environment, without generating pollutants and agents that can contaminate the product, and where human intervention to carry out the usual operations of the sector (cleaning, format change, maintenance, biological test monitoring or other) is reduced to a minimum, if not reduced to zero.

Therefore, one purpose of the present invention is to provide a machine and perfect the corresponding method to automatically transport one or more components to make a package from and to one or more working stations, which are reliable, functional and conceptually simple, and which at the same time work in an environmentally sustainable way, without generating noise, particulates and agents that contaminate the product.

Another purpose of the present invention is to provide a machine and perfect the corresponding method to automatically transport one or more components to make a package from and to one or more working stations, which have great versatility, that is, which have the possibility of carrying out, when desired, an easy change of the format and/or type of the component, or components, so as to transport them, from small ones, in the order of a few millimeters, to large ones, in the order of decimeters.

Another purpose of the present invention is to provide a machine to automatically transport one or more components to make a package from and to one or more working stations, which is provided with very sensitive and reliable gripping means to carefully grip and release each component to be transported, without gripping it too tightly, so as not to deform it or damage it.

Another purpose of the present invention is to provide a machine to automatically transport one or more components to make a package from and to one or more working stations, in which it is not necessary to use godets in which to dispose the components to be transported.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The corresponding dependent claims describe other characteristics of the invention or variants to the main inventive idea.

In accordance with the above purpose, a machine according to the present invention, to automatically transport a plurality of components to make a package from and to one or more working stations comprises: a reference surface, in association with which the one or more working stations as above are disposed and with which electric energizing means are associated, configured to selectively generate one or more magnetic fields; at least a first and a second support member each provided with magnetic means configured to interact with the one or more magnetic fields as above, in order to move each of the support members as above independently, without contact and without constraint in direction or path, on the reference surface from and to the one or more working stations; and control means configured to energize selectively and in a coordinated manner the electric energizing means as above, to cause the selective movement of each of the support member from one point to another of the reference surface.

In accordance with one characteristic of the present invention, each of the first and second support member as above is provided with respective gripping means comprising at least one support arm. The support arm of the first support member is configured to cooperate with the support arm of the second support member so as to temporarily support one or more of the components as above to make a package.

This aspect allows to grip and support, directly or indirectly with the use of supports, such as trays or nests, components even of different types, different formats and different sizes, without needing manual interventions and/or to stop the machine to possibly change the gripping means as a function of the shapes and sizes of the components to be moved together with the support members.

According to one possible embodiment, the gripping means as above are respectively attached to the first and to the second support member in a removable manner.

In accordance with another characteristic of the present invention, the reference surface as above can be of any shape and orientation whatsoever, that is, for example, horizontal, vertical, inclined, flat, curved, undulating, or mixed, or formed by flat zones and by curved or undulated zones.

According to possible embodiments, the reference surface as above comprises a zone disposed vertically that has at least one aperture through which the plurality of containers, coming from a feed zone, pass in order to make them available to the gripping means so that they can be transported by the support members.

In accordance with another characteristic of the present invention, the machine comprises elastic means associated with the gripping means as above, configured both to guarantee a stable grip by the gripping means and each component to transport, and also to cushion the impact of the gripping means during the transport of the plurality of components.

In accordance with some embodiments, the elastic means as above are intrinsic, defined by one or more suitably elastically yielding parts present in the mechanical chain that connects the support member to the gripping means.

In accordance with some embodiments, the elastic means as above are extrinsic, defined by one or more additional elastic components associated with the gripping means.

In accordance with another characteristic of the present invention, each of the first and second support arm is provided with one or more gripping seatings, configured to cooperate with the component, or the components, to be gripped and temporarily supported, which can be of various types and various formats, that is, have various geometries and sizes.

In accordance with another characteristic of the present invention, in one possible embodiment, the gripping means also comprise an additional arm, protruding from the respective support member and to which the support arm is transversely connected; such additional arm is shaped so that the support arm can keep the plurality of components raised to make a package with respect to the corresponding support member and/or support the plurality of components cantilevered with respect to the reference surface.

In possible embodiments, the additional arm as above has the elastic means.

In accordance with another characteristic of the present invention, the support arm as above is provided at one end with a comb-type support, shaped so as to define a plurality of gripping seatings, aligned with each other, each of which are configured to simultaneously grip one component of the plurality of components as above.

In accordance with another characteristic of the present invention, the support arm as above is provided at one end with a C-shaped support, configured to grip and support a tray provided with a plurality of seatings, for example through holes or a so-called nest, each of which is configured to accommodate each component of the plurality of components as above in order to make a package.

In accordance with another characteristic of the present invention, each of the support arms of the first and of the second support member comprises, at one respective end, the comb-type support as above.

In accordance with another characteristic of the present invention, in order to grip and support the nest or tray as above, at least two pairs support members are provided.

In accordance with other possible embodiments, each support arm of the first and second support member is provided with a plurality of projecting elements parallel and distanced from each other so as to define a plurality of gripping seatings, when the projecting elements of the arm of the first support member are adjacent to the corresponding projecting elements of the arm of the second support member with one component of the plurality of components interposed in a grip.

In accordance with yet other possible embodiments, the support arm of the first support member of the at least one pair of support members is provided at one end with a rack support formed by a central elongated body from which a plurality of gripping segments branch out, while the support arm of the second support member is provided at one end with a forked support from which a plurality of other gripping segments branch out toward the inside of the fork; wherein the rack support and the forked support are configured to cooperate with each other so as to create seatings to accommodate the plurality of components.

According to possible embodiments, the machine comprises feed means configured to feed the one or more components to the at least two support members used for transport.

In accordance with possible embodiments, the feed means can be selected from one or more, or a combination of, the following:
advance devices, in particular roll, belt, strap, or chain conveyors, magnetic tracks;
at least two further transport members configured to feed the one or more components, and being subjected to the at least two support members used for transport;
one or more automated or robotic mechanical operators, configured to feed the one or more components toward the at least two support members used for transport.

According to other possible embodiments, the machine comprises support means configured to receive and stably keep in position a plurality of components to be gripped and transported, before and waiting for the gripping means of the respective support members to cooperate to grip and support the one or more components for transport purposes.

According to other possible embodiments, which can be combined with all those described above, the reference surface as above comprises a zone disposed vertically that has at least one aperture through which the plurality of containers, coming from a feed zone, pass in order to make them available to the gripping means so that they can be transported by the support members.

In accordance with another characteristic of the present invention, a method to automatically transport one or more components to make a package from and to one or more working stations, by means of a machine that has: a reference surface in association with which the one or more working stations are disposed, and to which electric energizing means are associated, configured to selectively generate one or more magnetic fields; at least a first and a second support member each provided with magnetic means which interact with the one or more magnetic fields, moving each of the first and second support member independently, without contact and without constraint in direction or path on the reference surface from and to the one or more working stations as above; and control means configured to energize selectively and in a coordinated manner the electric energizing means as above to cause the selective movement of each of the first and second support member from one point to another of the reference surface, comprises at least a step of gripping the plurality of components, in which a support arm of the first support member cooperates with a support arm of the second support member, so as to temporarily support the plurality of components, at least a transport step, in which the plurality of components, even of different formats and different sizes, supported by the respective support arms of the first and second support member, are transported, for example in an independent manner, from one point to another of the reference surface, that is, from and to one or more of the working stations as above. This aspect allows to grip and support the components even of different shapes or sizes, within a determinate range of specific shapes and sizes, without needing manual interventions and/or to stop the machine to possibly change the gripping means, as a function of the shapes and sizes of the components to be moved together with the support members.

In accordance with one characteristic of the present invention, the method comprises a control step, in which the control means acquire information on the reciprocal positioning of the first and second support member and control the energizing of the electric energizing means in order to maintain an orientation and a predefined distance between the support arm of the first support member and the support arm of the second support member during the transport of the plurality of components as above.

In accordance with another characteristic of the present invention, the method also comprises, optionally, a preliminary step, prior to the gripping step, in which the control means command each of the support members so that it moves to an equipping zone in which an appropriate one of the gripping means is associated with each of the support members, preferably automatically and without human intervention, for example with the use of robotic equipment.

In accordance with another characteristic of the present invention, the method as above also comprises a step of preparing a nest or a tray provided with a plurality of seatings, each of which is configured to accommodate each component of the plurality of components; in the gripping step the support arm of the first support member cooperates opposite with the support arm of the second support member to grip the nest lifting it from a support plane and to transport it, in the transport step, from and to one or more of the working stations.

### ILLUSTRATION OF THE DRAWINGS

These and other characteristics of the present invention will become apparent from the following description of one preferred embodiment, given as a non-limiting example with reference to the attached drawings wherein:

FIG. 1 is a block diagram that shows a machine according to the present invention to automatically transport, from and to one or more working stations, a plurality of components to make a package using a reference surface;

FIG. 1a is an enlarged detail of FIG. 1;

FIG. 2 is a perspective and schematic view of a detail of the machine of FIG. 1 in accordance with one embodiment, configured to transport a first container of a small size;

FIG. 3 is a perspective and schematic view of a detail of the machine of FIG. 1 in accordance with the embodiment of FIG. 2, but in which the distance between the two support members is configured to transport a second container of the same type but with sizes larger than those of the first container of FIG. 2;

FIG. 4 is an enlarged detail of FIG. 1 seen from above and schematized;

FIG. 5 is a detailed view of gripping means which can be used in a machine in accordance with the present invention;

FIG. 6 is a view of FIG. 5 where some components have been removed for a better view;

FIG. 7 is a perspective and schematic view of a detail of the machine of FIG. 1 in accordance with other embodiments of the present invention;

FIG. 8 is a perspective and schematic view of a detail of the machine of FIG. 1 in accordance with another embodiment, but configured to transport the second container of FIG. 3 cantilevered with respect to a vertical reference surface;

FIG. 9 is a perspective and schematic view of a detail of the machine of FIG. 1 in accordance with another embodiment, but configured to transport the second container of FIG. 3 in a raised position with respect to a vertical reference surface;

FIG. 10 is a perspective and schematic view of a detail of the machine of FIG. 1 in accordance with other embodiments of the present invention;

FIG. 11 is a perspective and schematic view of a detail of the machine of FIG. 1 in accordance with another embodiment, configured to transport the second container of FIG. 3 on a horizontal reference surface;

FIG. 12 is a perspective and schematic view of a detail of the machine of FIG. 1 in accordance with the embodiment of FIG. 11, but configured to transport a single third container of a different nature and type from the first, consisting, for example, of a vial or syringe, with respect to a horizontal reference surface;

FIG. 13 is a perspective and schematic view of a detail of the machine of FIG. 1 in accordance with another embodiment, configured to simultaneously transport a plurality of third containers consisting of vials, or syringes, or Carpules®, for example three, on a vertical reference surface;

FIG. 14 is a perspective and schematic view of a detail of the machine of FIG. 1 in accordance with another embodiment, configured to simultaneously transport a plurality of second containers, for example three, on a horizontal reference surface;

FIG. 15 is a perspective and schematic view of a detail of the machine of FIG. 1 in accordance with another embodiment, configured to simultaneously transport a plurality of third containers consisting of vials, or syringes, or Carpules®, in a perforated tray, on a vertical reference surface, using a pair of gripping members;

FIG. 16 is a perspective and schematic view of a detail of the machine of FIG. 1 in accordance with another embodiment, configured to simultaneously transport a plurality of second containers, for example six, divided into two groups of three, on a vertical reference surface, using two pairs of gripping members;

FIG. 17 is a perspective and schematic view of a detail of the machine of FIG. 1 in accordance with another embodiment, configured to simultaneously transport a plurality of third containers consisting of vials, or syringes, or Carpules®, in a perforated tray which is the same as that of FIG. 15, on a vertical reference surface, using two pairs of gripping members;

FIG. 18 is a perspective and schematic view of a detail of the machine of FIG. 1 in accordance with another embodiment, configured to simultaneously transport a plurality of third containers consisting of vials in a perforated tray which is the same as that of FIG. 15, but on a horizontal reference surface, using two pairs of gripping members;

FIGS. 19, 20 and 21 are perspective and schematic views of a detail of the machine of FIG. 1 in accordance with other embodiments.

It should be noted that in the present description the drawings are not to scale and that they are provided only to illustrate the present invention to a person of skill in the art.

Furthermore, that in the different embodiments described hereafter, the same reference numbers have been used to identify substantially identical, or similar, objects, elements, members, components or parts of the machine, or ones that perform the same function.

### DESCRIPTION OF EMBODIMENTS

We will now refer in detail to the various embodiments of the invention, of which one or more examples are shown in the attached drawings. Each example is supplied by way of illustration of the invention and shall not be understood as a limitation thereof. For example, the characteristics shown or described insomuch as they are part of one embodiment can be adopted on, or in association with, other embodiments to produce another embodiment. It is understood that the present invention shall include all such modifications and variants.

Before describing the embodiments, we must also clarify that the present description is not limited in its application to details of the construction and disposition of the components as described in the following description using the attached drawings. The present description can provide other embodiments and can be obtained or executed in various other ways. We must also clarify that the phraseology and terminology used here is for the purposes of description only, and cannot be considered as limitative.

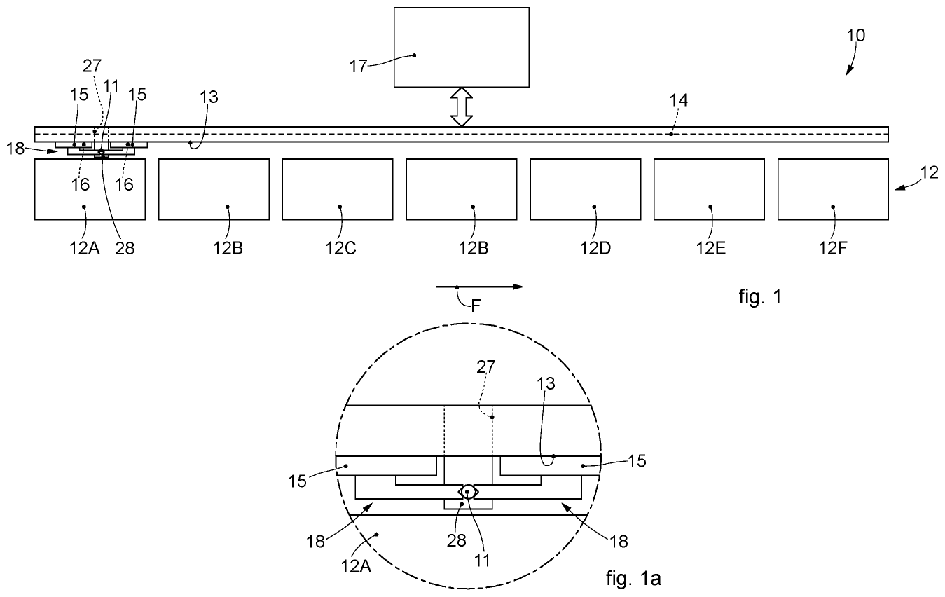

With reference to FIG. 1, embodiments are described of a machine 10 configured to automatically transport one or more components 11 to make a package, in particular a package for a pharmaceutical product (figs. from 2 to 21) from and to one or more working stations 12 (FIG. 1).

In particular, here and hereafter in the embodiments described, with the expression “component(s) to make a package” we mean a container, a cap, a ring nut or other elements or components necessary to make a package to contain a product of the type in question, for example a package for a pharmaceutical or medical product.

The product can be for example in liquid, powder, or solid form, for example tablets, pills, lozenges or other, or in gel form.

Here and hereafter in the description, the various embodiments will be described with reference to one container 11, or group of containers 11, as a possible example of a component, or group of components, in accordance with the present description. It is clear that the description of the embodiments also applies to other components of the type in question that are not containers, for example caps, ring nuts or other components or elements necessary to make a package.

In FIG. 1, by way of a non-limiting example, the working stations 12 comprise, although it is not necessary for each one of these to be present, a station 12A for storing the empty containers 11, one or more weighing stations 12B, of which there are two in the example provided here, a filling station 12C configured to fill the containers 11, a closing station 12D configured to close each container 11 and a packaging station 12E configured to package, or pack, the filled and closed containers 11. There could possibly also be a storage station 12F configured to store the packages, or packs, of containers 11 ready for use.

These stations 12 are aligned along a direction of feed F which defines the main direction of development of the machine 10. This direction of feed F is not necessarily represented by a straight line, but can also be a curve or a segment of a curve, for example, a circumference, an ellipse or other curve, or part thereof.

The present invention provides a gripping and transport assembly, described in detail below, configured to automatically grip and transport one or more containers 11 along the machine 10, for example in the direction of feed F, according to desired paths or directions, for example to carry out a desired working cycle as a function of the stations 12 which are specifically provided or used. As will become clear from the following description, the gripping and transport assembly according to the present invention is extremely versatile in terms of its application to a wide range of geometries and/or sizes of a same container and of different containers, since it is able to adapt automatically, without need for human intervention, to different formats, sizes and geometries of the containers to be transported.

It should be noted that the number and disposition of the working stations 12, which in FIG. 1 are shown aligned along a rectilinear path, exemplified by the direction of feed F, are described and schematically represented here only by way of example and to better explain the present invention. In fact, the disposition of the working stations 12 can be chosen as desired, as a function of the operational production requirements.

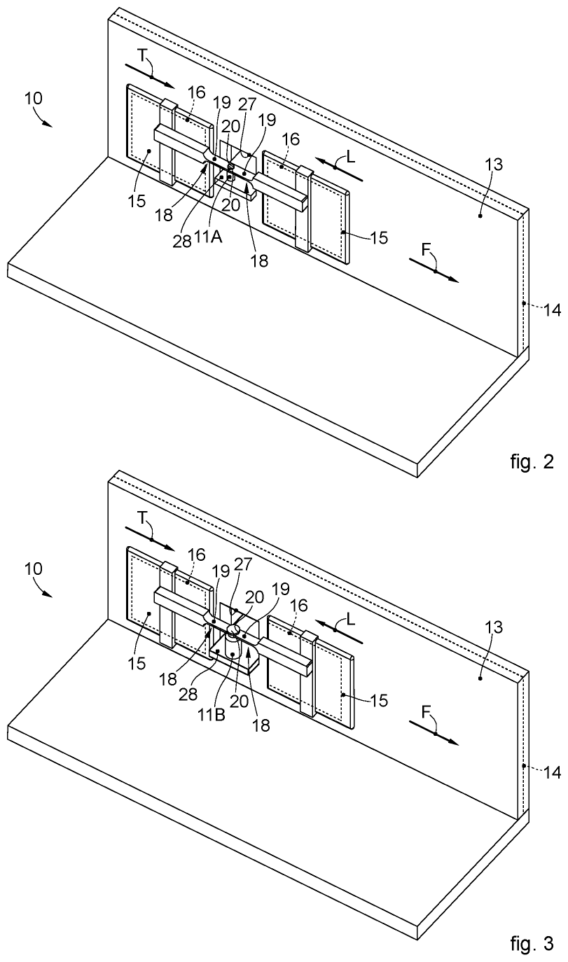

In turn, the containers 11 can have different shapes, sizes and therefore containing capacities, from a few milliliters to a few liters. Thus, for example, there may be a first container 11A (FIG. 2, 19, 20, 21), which has the shape of a small vial for drugs with an external diameter of the order of millimeters and a capacity of the order of milliliters, for example from 1 to 100 milliliters, a second container 11B (FIGS. 3, 7, 8, 9, 10, 11, 14 and 16) which has the shape of a vial with an external diameter of the order of centimeters and a capacity of the order of centiliters, for example from 1 to 100 centiliters, or a third container 11C (FIGS. 12, 13, 15, 17 and 18) which has the shape of a vial, a syringe or a Carpula®, with a capacity of the order of milliliters, for example from 1 to 100 milliliters.

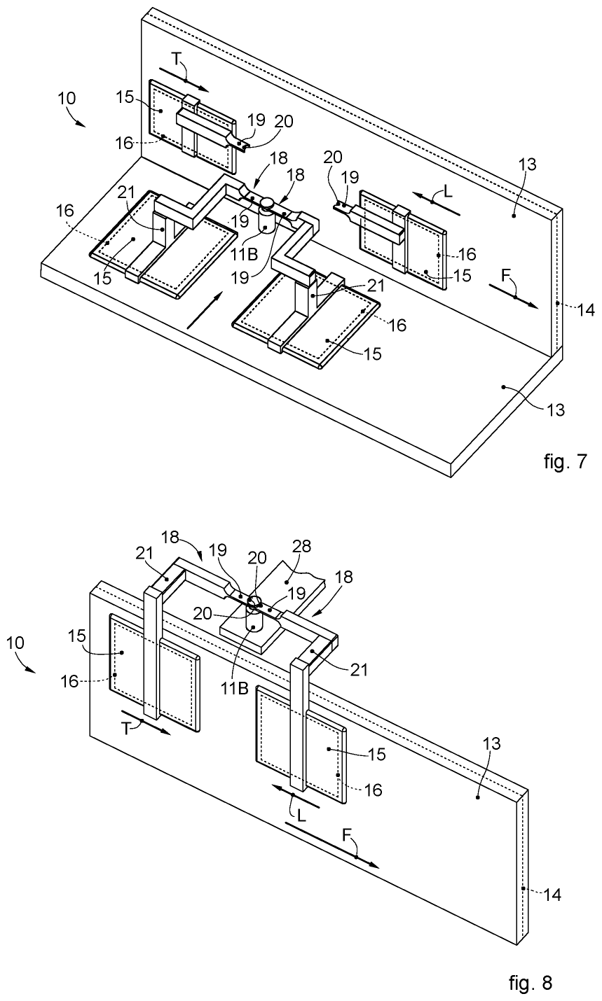

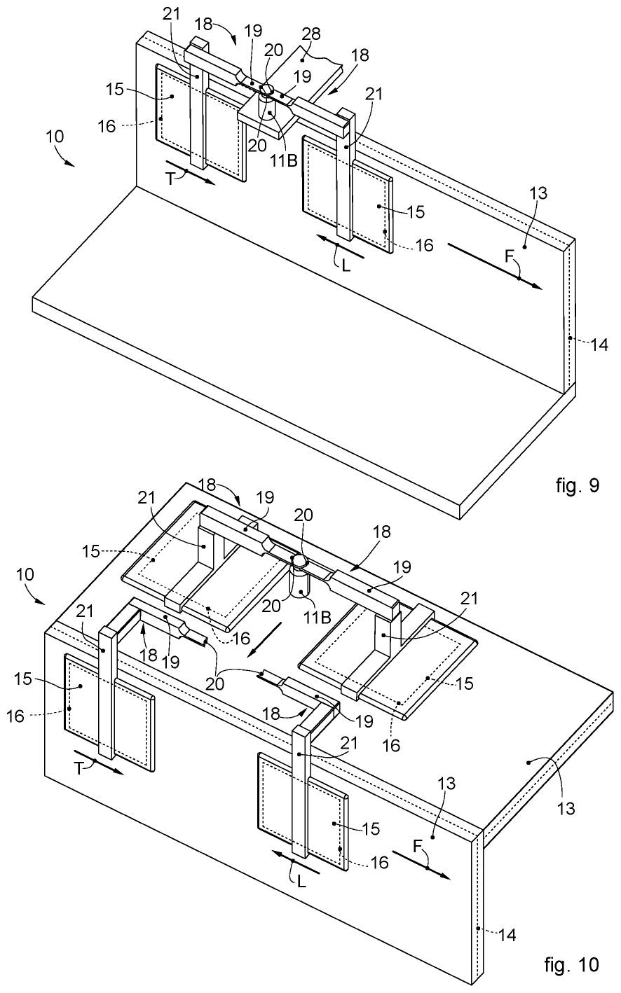

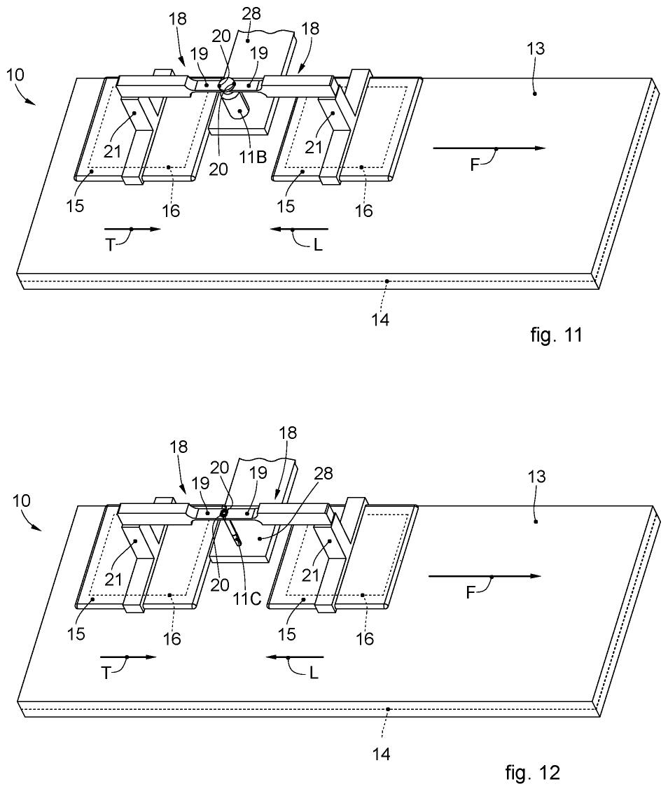

The machine 10 (FIGS. 1-3, 7-21) comprises a reference surface 13, which can be for example both vertical (FIGS. 2, 3, 7, 8, 9, 10, 13, 15, 16, 17, 19 and 20), and also horizontal (FIGS. 11, 12, 14, 18 and 21), and also a combination of vertical and horizontal (see for example FIGS. 7 and 10), and also inclined by a desired angle, or a combination of inclined surfaces, both flat, curved, undulating, and irregular (the latter not shown in the drawings, but easily understood by a person of skill in the art) and can, in some embodiments, also present any geometric discontinuity whatsoever.

With the reference surface 13 there are associated energizing means 14, of a known type and not shown in detail, which are configured to selectively generate one or more magnetic fields, also distributed locally, in determinate zones of the same reference surface 13. For example, the electric energizing means 14 comprise a plurality of electric coils or windings, not shown in the drawings, suitably disposed in correspondence with the reference surface 13.

A plurality of support members 15 are associated with the reference surface 13 (FIGS. 2, 3, 7-21) which, as described hereafter, are part of the gripping and transport assembly as above. In possible implementations, each of these support members 15 can have the shape of a plate, or a tile or other desired shape. For example, these support members 15 can have a regular or irregular polygonal base, that is, plan, in particular quadrangular, for example square or rectangular, or other polygonal shapes and possibly non-regular polygonal shapes, defined by a closed broken line which for example defines an L- or C-shaped profile.

In some embodiments, each of these support members 15 is provided with magnetic means 16, such as for example permanent magnets, of a known type and not shown in detail in the drawings. The magnetic means 16 are configured to interact with one or more of the magnetic fields as above generated by the electric energizing means 14, so that each of the support members 15 can move independently on the reference surface 13 and slightly distanced from the latter, therefore without contact, along the machine 10, for example from and to one or more working stations 12, or in different positions within a same working station 12.

It should be noted here that the gripping and transport assembly as above, configured to grip and transport one or more containers 11 along the machine 10 as described above, therefore comprises the support members 15 which, by virtue of the magnetic interaction between magnetic means 16 present therein and the magnetic fields selectively generated by the electric energizing means 14 associated with the reference surface 13, can be supported at a desired distance from the reference surface 13 and can be moved without contact in a desired trajectory, and therefore can advantageously support and/or move objects or products which, according to requirements, can be gripped and supported by them for transport purposes, as will be explained in detail below, along the reference surface 13. The latter therefore represents a movement surface along which the support members 15 can be supported and moved without contact.

These support members 15 can therefore be made by means of so-called “planar motors” with magnetic drive, which are known in the art.

The support members 15 are disposed on the reference surface 13 and configured to be moved and/or rotated, as well as independently and without contact, also without any constraint in direction or path, advantageously in several degrees of freedom, in this specific case being able be moved and/or rotated potentially in six degrees of freedom.

Such six degrees of freedom can be along three directions of a triad of orthogonal reference directions, similarly to a triad of Cartesian axes, and angularly around each of the directions of the triad.

Therefore, these support members 15 can be moved or rotated in at least two, or more, degrees of freedom, for example even three, four, five or six degrees of freedom, also providing combined movements in more of such degrees of freedom, according to requirements.

The selective energizing of the electric energizing means 14 is controlled by control means which, in the example provided here, consist of, or comprise, a central processing unit 17 (FIG. 1), such as for example a microcontroller, an industrial PC or a Programmable Logic Controller (PLC), also of a known type and which can be programmed on the basis of the state of the art concerning so-called planar motors, which have been studied and developed for over twenty years. In particular, the central processing unit 17 selectively controls in a programmed manner the values of electrical current and/or voltage to be supplied to the electric energizing means 14, so that the latter can determine both the support of each support member 15 in a determinate position of the reference surface 13, and also the selective movement of each support member 15 along the machine 10, for example from one point to another of the same reference surface 13, both from and also to one or the other of the working stations 12.

In order to grip and support, directly or indirectly by means of a suitable support, such as a tray or nest 24, the containers 11 to be transported, each support member 15 is provided with gripping means 18 configured to selectively grip and temporarily support, in cooperation with corresponding gripping means 18 of at least another support member 15, one or more containers 11 or respective nests or trays 24 containing said containers 11, as described below. Hereafter, we will refer to the support members 15 cooperating reciprocally to temporarily support the containers 11 indifferently with the expressions “pair of support members 15”, or “first support member” and “second support member”, both identified by reference number 15.

Advantageously, the gripping means 18 of at least one pair of support members 15 automatically define, thanks to the cooperation of one pair of such support members 15 as explained in detail below, a special component for gripping and transporting the containers 11 which proves to be extremely versatile in terms of its application to a wide range of geometries and/or sizes of a same container and of different containers or of respective nests or trays 24 containing said containers 11.

In some embodiments, the machine 10 can include support means 28 (see for example FIG. 1a, 2, 3, 8, 9, 11-21) for the containers 11 or nest or trays 24 containing said containers 11.

In possible implementations, such support means 28 can include for example a plate, a bar, a shelf or similar support element. These support means 28 can be static, fixed in one or more predefined positions, or dynamic, that is, their position can be modified as needed.

Such support means 28 are, in particular, able to receive and stably keep in position one or more containers 11, or respective nests or trays 24 containing said containers, to be gripped and transported, before and waiting for the gripping means 18 of the respective support members 15 to cooperate to grip and support the one or more containers 11, or respective nests or trays 24 containing said containers 11.

For example, in some embodiments (FIGS. 1, 1a, 2, 3, 13, 15, 16, 17, 19, 20, 21), the support means 28 can be projecting cantilevered from the respective reference surface 13.

In other embodiments (FIGS. 8, 9, 11, 12, 13, 18), the support means 28 can be provided astride the respective reference surface 13, for example protruding partly on one side, and partly on the other side thereof.

The position of these support means 28 on, or with respect to, the reference surface 13 can be associated with a specific operating gripping zone defined on the reference surface 13, where the support members 15, provided with the gripping means 18, are programmed to go in order to grip and support the containers 11, or respective nests or trays 24 containing said containers 11, to be transported.

Feed means can be provided, which are configured to supply the containers 11, or respective nests or trays 24 containing said containers 11, directly to the support members 15 suitable to transport them and/or to position them on the support means 28, waiting to be gripped and supported by the gripping means 18 of support members 15 which cooperate as described above for transport purposes.

For example, in some embodiments the feed means as above can include roll, belt, strap, or chain conveyors, magnetic tracks or other advance devices.

In possible embodiments, the support means 28 can be made as a single body, or made up of several components, in any case in such a way that one of their parts is disposed on the side of the reference surface 13 where the support members 15 are operating, while another one of their parts is disposed on the opposite side, thus for example avoiding, or reducing, possible contaminations between the two sides, and environments, which are opposite with respect to the reference surface 13.

In other embodiments, the machine 10 can have at least one aperture 27 (see for example FIGS. 1, 2, 3, 12, 15, 16, 17, 19, 20, 21), for example made through the respective reference surface 13, through which the containers 11, or respective nests or trays 24 containing said containers 11, are made to pass from a feed zone, where the feed means are operative, to the operating gripping zone in order to make them available to the gripping means 18 so that they can be transported by the support members 15 cooperating with each other. In some embodiments, the support means 28 can for example be provided in a coordinated position, in particular aligned, with the aperture 27. In this case, the feed means can be disposed in correspondence with the aperture 27.

In yet other embodiments, described using FIGS. 7 and 10, the feed means can include other support members 15, or groups of support members 15 as described here, which are also equipped with respective gripping means 18 and which, for example, can move on another reference surface 13, suitably disposed with respect to the reference surface 13 as above. This other reference surface 13 can therefore act as support means 28 as described above.

In such embodiments, therefore, at least two support members 15 can be subjected to the at least two support members 15 used to grip and support the containers 11 for transport purposes.

In FIG. 7, in particular, the pair of support members 15 present on the vertical reference surface 13 is for example able to transport, as described with reference to FIGS. 2 and 8 respectively, while the other pair of support members 15 on the horizontal reference surface 13 is provided to feed the containers 11, therefore subjected to the two support members 15 present on the vertical reference surface 13.

Similarly, in FIG. 10, in particular, the pair of support members 15 present on the horizontal reference surface 13 is for example able to transport, as described with reference to FIGS. 11 and 12 respectively, while the other pair of support members 15 on the vertical reference surface 13 is provided to feed the containers 11, therefore subjected to the two support members 15 present on the horizontal reference surface 13.

In still further embodiments, the feed means can be made by the same support members 15 used for transport, which can be suitably configured and programmed to go and collect the containers 11 to be transported.

In these embodiments, the other support members 15 act as feed means and are therefore able to feed or supply the containers 11, or the respective nests or trays 24 containing said containers 11, to the other support members 15 used to grip and transport the containers 11, or the respective nests or trays 24 containing said containers 11, as explained above. In this way, advantageously, the point or the zone where the support members 15, used to transport the containers 11, or the respective nests or trays 24 containing said containers 11, between the various stations 12, perform the gripping of the containers 11, or the respective nests or trays 24 containing said containers 11, fed by the feed means thus made, can also not be fixed but can vary according to specific needs.

In accordance with still other embodiments, the feed means can comprise one or more automated or robotic mechanical operators, such as robotic arms or manipulators, configured to feed the containers 11 toward the respective support members 15 used to transport them on the reference surface 13.

In possible embodiments, the feed means, or part of the feed means, can themselves act as support means 28 to receive and stably keep in position the containers 11, before and waiting for the gripping means 18 of the respective support members 15 to cooperate to grip and support the one or more components 11 for transport purposes. Thus, for example, the support means 28 can be formed by the advance devices as above, or by other support members 15 used for and subjected to feeding the containers 11 toward other support members 15 used for transport, or also by components of automated or robotic mechanical operators, as described above.

In accordance with the embodiments described here, the gripping means 18 can have various shapes and sizes with the aim that the gripping means 18 adapt automatically with respect to a wide range of shapes and/or sizes of the containers 11, or of the respective nests or trays 24 containing said containers 11.

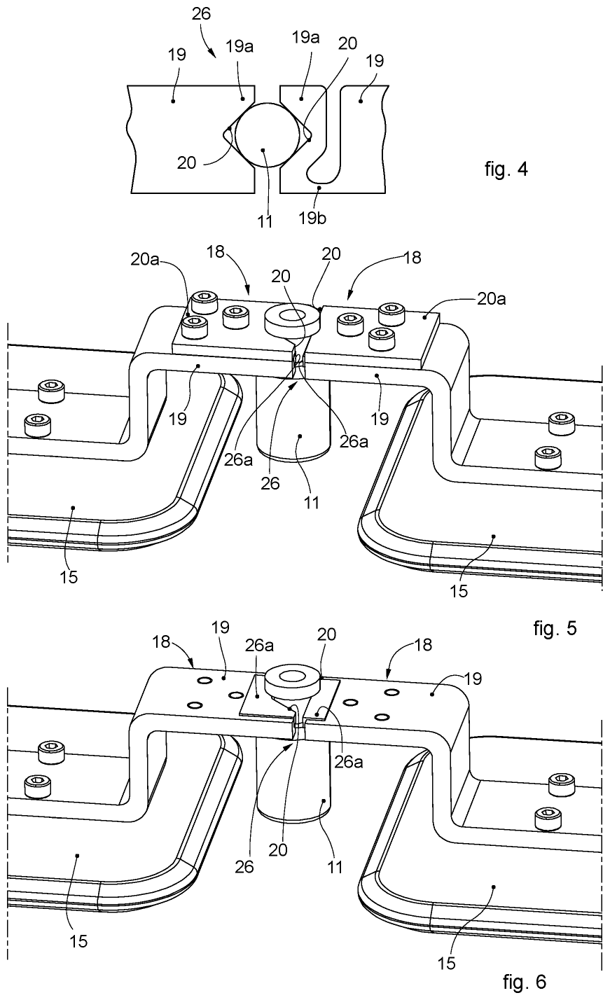

For example, in one possible embodiment, the gripping means 18 comprise a support arm 19 (FIGS. 2-21) which has, for example at one end 19a thereof (FIG. 4), a gripping seating 20, for example V-shaped, or any other suitable shape whatsoever, for example semicircular, or other, to cooperate with a container 11 to be transported, which can be of various types and of various formats, that is, have various geometries and sizes.

The gripping seatings 20 of respective support arms 19 of the support members 15 can be the same, or different, according to requirements.

The gripping seating 20 is advantageously configured to be self-centering, defining a lead-in shape which, in cooperation with a respective gripping seating 20 of the gripping means 18 of another support member 15, allow to grip and support in a stable, safe and reliable manner, a respective container 11. In particular, these embodiments are advantageous since they allow to self-adapt to a desired range of shapes and sizes of the containers 11, without needing, as explained in detail below, manual interventions to replace the gripping components for the purpose of changing the format of the containers 11 to be processed.

Preferably, in some embodiments, elastic means and/or cushioning means 26 (FIGS. 4, 5, 6) can be associated with each gripping mean 18, both to guarantee, with certainty, that the contact between the latter and each container 11 occurs, and also to cushion the impact of the same gripping means 18 on each gripped container 11. Advantageously, therefore, these elastic means and/or cushioning means 26 are configured to manage the tolerances of the container 11 and ensure the grip on the container 11 itself.

In some embodiments, the elastic and/or cushioning means 26 can be associated with the respective gripping means 18 in an intrinsic manner or, in other embodiments, in an extrinsic manner.

For example, in embodiments described using FIG. 4, the elastic means and/or cushioning means 26 can be intrinsic, that is, defined by one or more suitably elastically yielding parts present in the mechanical chain that connects the support member 15 to the gripping means 18 and to the respective gripping seatings 20. In possible implementations, the intrinsic elastic means and/or cushioning means 26 can comprise the end 19a of at least one support arm 19, suitably configured or made elastic and/or flexible or elastically yielding. For example, it is possible to provide that, in the proximity of the end 19a of at least one support arm 19, there is a reduction in section 19b, which makes the end 19a itself flexible and elastic. It is clear that a person of skill in the art will be able to use many other solutions known in the art to make the ends 19a of the support arms 19 elastic and/or cushioning.

It should therefore be noted how, by virtue of the self-adapting and self-centering capacity of the gripping means 18, the change of format of the containers 11, between the one shown in FIG. 2 and the one shown in FIG. 3, does not require any physical or mechanical change of the support members 15 to satisfy the need to transport a wide range of shapes and/or sizes of the containers 11 and does not require any human intervention.

In other embodiments, described using FIGS. 5 and 6, the elastic means and/or the cushioning means 26 can be extrinsic, that is, be one or more additional elastic components 26a present on the gripping means 18, for example in correspondence with the respective gripping seatings 20, and include, for example, elastic elements, such as shims, dowels, inserts, annular elements, such as O-rings, made of elastomeric material, or rubber, which can be present on or added to the part of the gripping means 18, for example the respective gripping seating 20, which comes into contact with the container 11, or the respective nest or tray 24.

In particular, in the embodiments described using FIGS. 5 and 6, each support arm 19 can be provided with a respective additional elastic component 26a shaped in a manner mating with the respective gripping seating 20 in correspondence with which it is disposed and kept in position by a corresponding closing or clamping block 20a. In FIG. 6, having removed the closing or clamping blocks 20a for ease of viewing, the respective additional elastic components 26a of FIG. 5 can be seen in full.

The characteristics present in the embodiments described using FIGS. 1-7, 10 are valid or can be combined, where applicable, also in the following other embodiments described using FIGS. 8-21.

In particular, according to another embodiment, shown in FIGS. 8 and 10, the gripping means 18 also comprise an additional arm 21 protruding from the respective support member 15 and to which said support arm 19 is transversely connected; this additional arm 21 is shaped so that the support arm 19 can support the container 11 cantilevered with respect to the reference surface 13, which in this case is vertical. In another embodiment, shown in FIG. 9, the additional arm 21 is shaped so that the support arm 19 can keep the container 11 raised with respect to the corresponding support member 15.

In another embodiment, shown in FIGS. 11 and 12, the additional arm 21 is shaped so that the support arm 19 can keep the container 11 raised with respect to the corresponding support member 15 and to the reference surface 13, which in this case is horizontal.

In the embodiments described using FIGS. 2, 3, 7-12, in which support members 15 are provided with gripping means 18 for gripping a container 11, the latter can be gripped with an approach movement, or trajectory, of the support members 15 to the container 11 to be taken, which occurs in respective directions of movement T, L which are concurrent and aligned with each other; in this way, the gripping is carried out by the support members 15 by means of a movement which has a component parallel to the direction of feed F and lies on the feed plane defined by the reference surfaces 13.

If required, thanks to the fact that the support members 15, as described above, can be mobile in multiple degrees of freedom, the trajectory performed by the support members 15, for example in the four cases of approach trajectory to grip the containers 11, de-constraint trajectory after gripping the containers 11, release trajectory of the containers 11 and de-constraint trajectory after the containers 11 have been released, can also have a component not parallel to the main direction of feed F of the machine 10. For example, with reference to FIGS. 2 and 3, the support members 15 can also have a speed component vertical or perpendicular to the reference surface 13 in the four cases as above.

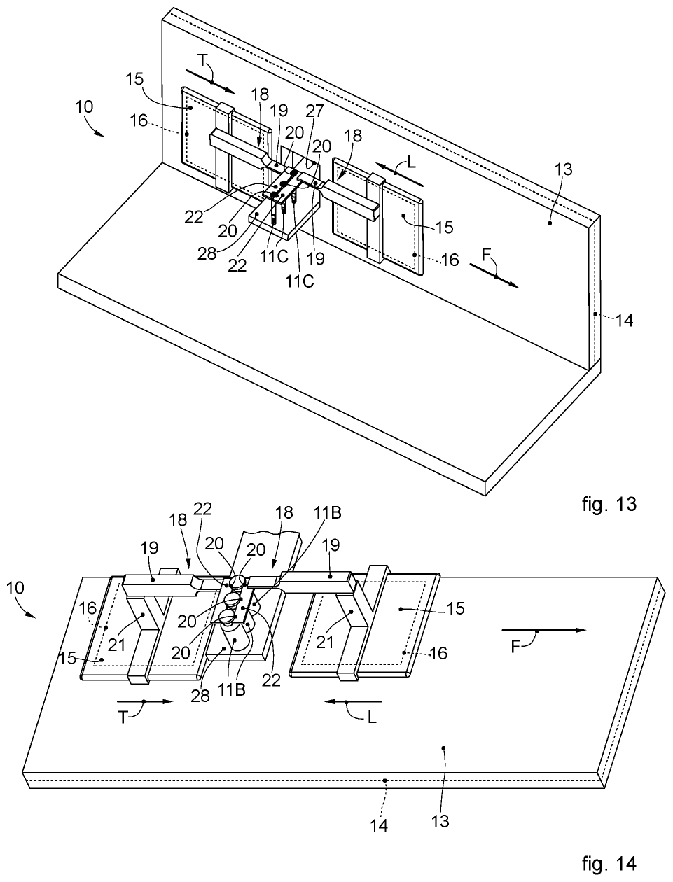

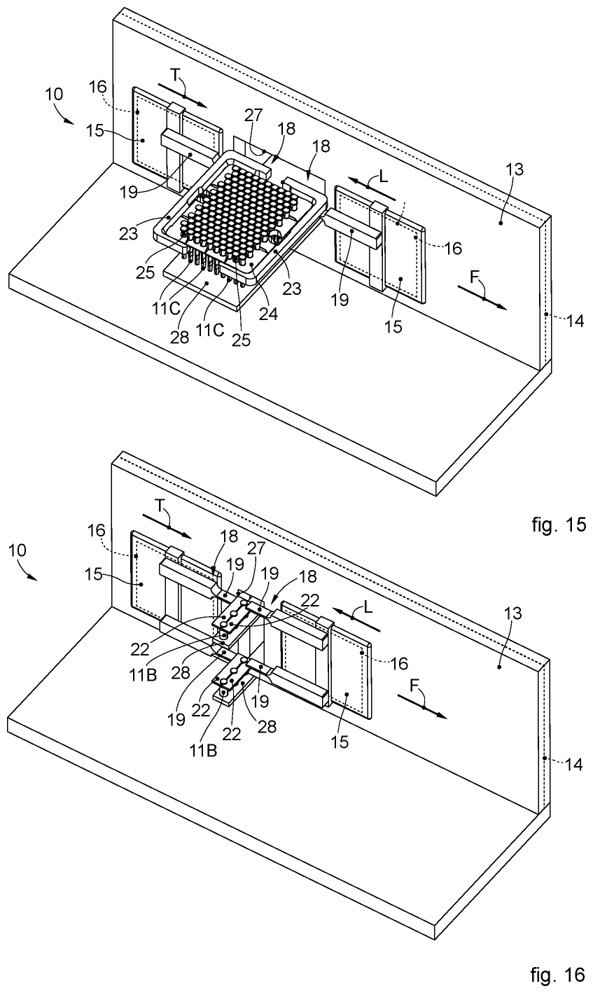

Other embodiments, described using FIGS. 13-21 and which can be combined with all the embodiments described here where applicable, can provide that the gripping means 18 are configured to simultaneously grip a plurality of containers 11 (FIGS. 13, 14, 16, 19, 20, 21), or a nest or tray 24 able to support in turn a plurality of containers 11 (FIGS. 15, 17, 18).

In particular, in accordance with one embodiment, shown in FIG. 13, the support arm 19 of each support member 15 is provided at one end with a comb-type support 22, shaped so as to define frontally a plurality of gripping seatings 20, aligned with each other, which in the example provided here are three, but which could also be in a number smaller or greater than three, which are configured to simultaneously grip a corresponding number of containers 11.

Also in another embodiment, shown in FIG. 14, each support arm 19 is provided at one end with a comb-type support 22 similar to that of FIG. 13.

Furthermore, in each support member 15 there is an additional arm 21 similar to that of FIGS. 8 and 12, to keep the containers 11 raised with respect to the horizontal reference surface 13.

In another embodiment, shown in FIG. 15, each support arm 19 is provided at one end with a C-shaped support 23, configured to grip and support a nest or a tray 24 provided with a plurality of seatings 25, consisting, for example, of through holes, regularly distributed in rows, alternately offset one with respect to the adjacent one. Each seating 25 is configured to accommodate, for example, a corresponding container 11C. It is clear that other types of containers 11 can be positioned in each nest or tray 24, such as for example those shown in figs. from 2 to 9.

In another embodiment, shown in FIG. 16, each support member 15 comprises at least two support arms 19, each provided, at one respective end, with a comb-shaped support 22, similar to that shown in FIG. 13, so that a corresponding number of containers 11, which in the example shown here is six, can be gripped simultaneously.

It should be noted that in the embodiment described with reference to FIG. 11, the containers 11 are developed in a direction perpendicular to the vertical reference surface 13. It is clear that, in accordance with one variant, not shown in the drawings, but easily understandable for a person of skill in the art, the containers 11 can also be disposed in another direction, for example parallel to the plane of the reference surface 13, or oriented in any way whatsoever with respect to the main direction of feed of the machine 10.

In accordance with other embodiments, which can be combined with all the embodiments described here where applicable, in order to simultaneously grip and support a plurality of containers 11, or the nest or tray 24 as above, the machine 10 can include at least two pairs of support members 15.

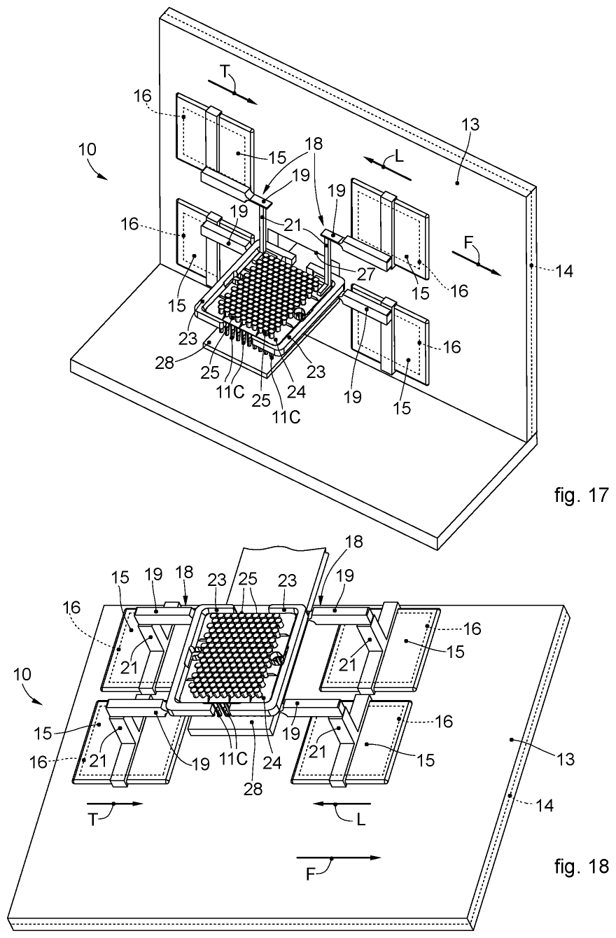

For example, according to one embodiment, shown in FIG. 17, in order to grip and support a tray 24, for example the same as that shown in FIG. 15, at least two pairs of support members 15 are provided, of which a first, lower one, can for example be the same as that shown in FIG. 15, while each support member 15 of a second, upper one, is provided with an additional arm 21 configured to cooperate with the tray 24 to keep it in a desired position during the transport of the corresponding containers 11C from or to a working station 12.

In another embodiment, shown in FIG. 18, configured to be associated with a horizontal reference surface 13, two pairs of support members 15 each support a C-shaped support 23 which can be the same as that shown in FIG. 15 to support a nest or tray 24 and the corresponding containers 11C.

Also in the embodiments described using FIGS. 13, 14, 16, in which several containers 11 are gripped by means of comb-type supports 22 with gripping seatings 20 made frontally, or using FIGS. 15, 17, 18, in which C-shaped supports 23 are provided, the containers 11 (FIGS. 13, 14, 16), or the respective nests or trays 24 (FIGS. 15, 17 and 18) are gripped with an approach movement, or trajectory, of the support members 15 to the containers 11, or the respective nests or trays 24, to be taken, which occurs in respective directions of movement T, L which are concurrent and aligned with each other; in this way, the gripping is carried out by the support members 15 by means of a movement (directions of movement T, L) parallel to the direction of feed F and lying on the feed plane defined by the reference surface 13. Also in this case, by virtue of the fact that the support members 15 can be mobile in several degrees of freedom, the trajectory performed by the support members 15 can also have a component not parallel to the main direction of feed F of the machine 10, for example a speed component vertical or perpendicular to the reference surface 13, similarly to what described above.

In the embodiments described using FIGS. 13, 14, 16, in which several containers 11 are gripped by means of comb-type supports 22 with gripping seatings 20 made frontally, or using FIGS. 15, 17, 18, in which C-shaped supports 23 are provided, each comb-type support 22 (FIGS. 13, 14, 16) or C-shaped support 23 (FIGS. 15, 17 and 18) lies on a respective horizontal lying plane, which can be parallel to the reference surface 13 with which the respective support members 15 are associated in the event the reference surface 13 is for example horizontal, or the horizontal lying plane as above can be transverse or differently inclined, for example perpendicular, in the event the reference surface 13 is for example vertical, or suitably inclined with respect to the horizontal, in the case of neither horizontal nor vertical surfaces.

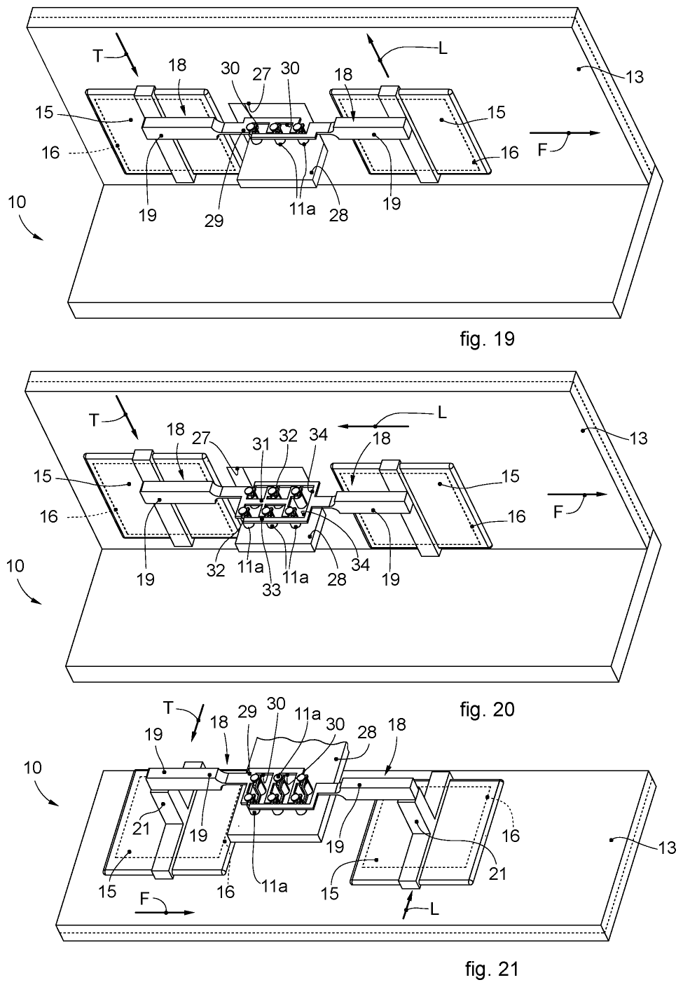

FIGS. 19, 20 and 21 show other advantageous embodiments which allow to grip and transport the containers 11 in an extremely versatile manner in terms of application to a wide range of geometries and/or sizes of a same container 11 and of different containers 11 and which can be applied to many containers 11 simultaneously, allowing the absence of a physical godet that has to be changed for each format change.

In these embodiments it is necessary for the approach movement, or trajectory, of at least one of, or both, the support members 15 toward the containers 11, or the respective nests or trays 24, to be taken, to also occur in respective directions of movement T, L which are not parallel to the direction of feed F. For example, in the embodiments described using FIGS. 19 and 21 such directions of movement T, L are parallel to each other and with opposite sense, while in the embodiments described using FIG. 20 such directions of movement T, L are transverse to each other and converging toward the containers 11 to be gripped. In this way, in the embodiments described using FIGS. 19, 20 and 21 the gripping is carried out by the support members 15 by means of at least one transverse movement, more particularly perpendicular, or parallel (directions of movement T, L), to the direction of feed F and lying on the feed plane defined by the reference surface 13. In the embodiments described using FIGS. 19 and 21 both the directions of movement T, L are transverse, in particular perpendicular, to the direction of feed F, while in the embodiments described using FIG. 20 one of the directions of movement, for example T, is transverse, in particular perpendicular, to the direction of feed F, while the other direction of movement, for example L, is aligned or parallel to the direction of feed F. To this end, in the embodiments described using FIGS. 19 and 21 each support arm 19 of the two support members 15 is provided, in particular in correspondence with one end thereof, with a plurality of projecting elements parallel and distanced from each other, defining a comb-type support, indicated as a whole with reference number 29 in FIGS. 19 and 21, and shaped so as to define a plurality of gripping seatings 30. In particular, these gripping seatings 30 are defined when the projecting elements of the support arm 19 of one of the support members 15 are adjacent to the corresponding projecting elements of the support arm 19 of the other support member 15, with a respective component 11 interposed in a grip. In this way, the projecting elements, parallel and distanced from each other, are configured to cooperate with each other in order to enclose and simultaneously grip from the side and stably maintain in the gripping seatings 30 a corresponding number of containers 11. The gripping seatings 30 are shaped and sized so as to adapt to different sizes or geometries of the containers 11 to be gripped and supported.

In the embodiments described using FIG. 19, each comb-type support 29 lies on a respective lying plane that is transverse, in particular perpendicular, to the reference surface 13 with which the respective support members 15 are associated. In such embodiments, the reference surface 13 can be for example vertical.

In the embodiments described using FIG. 21, each comb-type support 29 lies on a respective lying plane parallel to the reference surface 13 with which the respective support members 15 are associated. In such embodiments, the reference surface 13 can be for example horizontal.

In the embodiments described using FIG. 20, on the other hand, one support arm 19 of one support member 15 is provided at one end with a rack support 31 formed by an elongated central body from which a plurality of gripping segments 32 branch out, while the other support arm 19 of the other support member 15 is provided at one end with a forked support 33 from which a plurality of other gripping segments 34 branch out toward the inside of the fork, with a shape mating with the rack support 31. In this way, the gripping means 18 are configured to simultaneously grip a plurality of containers 11, taken in the respective gripping seatings 32, by means of a combined transverse movement from above and frontal of the two support members 15. Also in this case, the gripping seatings 32 are shaped and sized so as to adapt to different sizes or geometries of the containers 11 to be gripped and supported.

In the embodiments described using FIG. 20 it is also possible to provide the presence of an additional arm 21 for each gripping mean 18, in a manner analogous to that described with reference to FIGS. 8-12, 14, 18.

In the embodiments that provide an additional arm 21, and described using FIGS. 8-12, 14, 18 and 21, it is also possible to provide that the elastic means and/or cushioning means 26 are made intrinsically as a part which is elastically yielding, or extrinsically by means of one or more additional elastic components 26a on the additional arm 21, in a completely analogous manner to what is described with reference to the support arm 19 with reference to FIGS. 4, 5 and 6.

It is understood that, as indicated above, also in these embodiments described using FIGS. 19, 20 and 21, thanks to the possibility of moving in several degrees of freedom, the trajectory performed by the support members 15 can also have a component not parallel to the main direction of feed F of the machine 10, for example a speed component vertical or perpendicular to the reference surface 13, similarly to what described above.

Favorably, in the embodiments described here, the gripping means 18 can lie on an essentially horizontal lying plane, so that the containers 11 are supported and transported in a stable manner, without the risk that their contents escape during movement or other operations provided in the machine 10. In the embodiments in which for example the reference surface 13 is horizontal (for example FIGS. 11, 12, 14, 21), the lying plane of the gripping means 18 is, therefore, advantageously parallel to the horizontal reference surface 13, while in the embodiments in which for example the reference surface 13 is vertical (e.g. FIGS. 2, 3, 7, 8, 9, 10, 13, 15, 16, 17, 19, 29), or differently inclined with respect to the horizontal, the lying plane of the gripping means 18 is advantageously transverse to the reference surface 13, in particular perpendicular if the reference surface 13 is vertical.

The embodiments of the present invention as above, provided by way of non-limiting examples, should make it clear to a person of skill in the art that many other forms of gripping means 18 associated with the support members 15 are possible, without departing from the field and scope of the present invention.

The functioning of the machine 10 described so far, which substantially corresponds to the method to automatically transport one or more containers 11 from and to one or more working stations 12 (FIG. 1) according to the present invention, is as follows.

In an initial condition of the machine 10, the various containers 11 are in the storage station 12A and each support member 15 is provided with the appropriate gripping means 18 for gripping one or more of such containers 11.

Optionally, a preliminary step can be provided, in which the central processing unit 17 commands each support member 15 so that it moves to a tooling zone, not shown in the drawings, in which each of them is associated with the appropriate gripping mean 18, preferably automatically and without human intervention, for example by using robotic equipment.

Then follows a step of gripping one or more containers 11, simultaneously or not, in which by using the gripping means 18 of at least one pair of support members 15, one or more containers 11 are simultaneously gripped and supported.

To this end, the method comprises a control step, in which the central processing unit 17 acquires information on the reciprocal positioning of the first and second support member 15 and controls the energizing of the electric energizing means 14 in order to maintain an orientation and a predefined distance between the support arms 19 of the pair of support members during the transport of the components 11.

The force with which the support members 15 of each pair driven to grip and support containers 11 is regulated by the central processing unit 17, so that the reciprocal approach and gripping movements of each pair of support members 15 are such as not to over-tighten each container 11, so as not to deform or damage it, but which on the other hand are such as to guarantee the effectiveness of the grip and transport.

Then follows a transport step, in which one or more containers 11, kept gripped, with sufficient but not excessive force, between the pair of gripping means 18 thus temporarily formed, are transported from one point to another of the reference surface 13, that is, from and to one or more of the working stations 12.

From the above it is clear that all the steps of the operating cycle described above can be automatically managed by the central processing unit 17 and therefore that the machine 10 achieves all the purposes set out, in particular those of:
transporting one or more containers 11 from one working station 12 to another, in a reliable, functional and cost-effective manner, in an environment that can be safe, ecologically sustainable and silent, that is, without generating particulate matter and noise, and where human intervention is reduced to a minimum, if not even eliminated;
obtaining high versatility; in fact, the machine 10, thanks to the configuration of the gripping means 18 described above, has the intrinsic capacity to deal with changes in format and type of the product, provided that their geometric shape remains similar or in any case within a predetermined range or variety of shapes and/or sizes, of each container 11 to be transported, from those of small sizes, of the order of millimeters, to those of large sizes, of the order of decimeters, simply by mounting in the support members 15 the gripping means 18 suitable to grip the chosen containers 11 to be transported, without having to intervene neither on the reference surface 13, nor on the electrical energizing means 14, nor on the support members 15, nor on the magnetic means 16, but appropriately managing and commanding, by means of the central processing unit 17, the distance between the two support members 15, or between the magnetic means 16;
not needing to use, to transport the containers 11, any accessory element whatsoever, for example known as a “godet”, in which to dispose the same containers 11, since the cooperation of the respective gripping means 18 of at least one pair of support members 15 automatically defines a special component for gripping and transporting the containers 11 which is extremely versatile in terms of its application to a wide range of geometries and/or sizes of a same container and of different containers.

It is clear that modifications and/or additions of parts may be made to the machine 10 and to the corresponding method as described heretofore, without departing from the field and scope of the present invention.

It is also clear that, although the present invention has been described with reference to some specific examples, a person of skill in the art shall certainly be able to achieve many other equivalent forms of machines and methods to automatically transport one or more containers from and to one or more working stations, having the characteristics as set forth in the claims and hence all coming within the field of protection defined thereby.

1. Machine to automatically transport, from and to one or more working stations, a plurality of components to make a package, said machine comprising:
a reference surface, in association with which said one or more working stations are disposed and with which electric energizing means are associated, configured to selectively generate one or more magnetic fields;
at least a first and a second support member each provided with magnetic means) configured to interact with said one or more magnetic fields, to move each of said first and second support member independently, without contact and without constraint in direction or path, on said reference surface from and to said one or more working stations;
control means configured to energize selectively and in a coordinated manner said electric energizing means to cause the selective movement of each of said first and second support member from one point to another of said reference surface, characterized in that each of said first and second support member is provided with respective gripping means comprising at least one support arm, the support arm of said first support member being configured to cooperate with the support arm of the second support member so as to temporarily support said plurality of components, and in that said control means are also configured to acquire information on the reciprocal positioning of said first and second support member and to energize said electric energizing means so as to move said first and/or second support member in order to maintain an orientation and a predefined distance between the support arm of said first support member and the support arm of said second support member during the transport of said plurality of components.

2. Machine as in claim 1, characterized in that said information on the reciprocal positioning of said first and second support member comprise the measurement of a gripping force exerted between the support arm of said first support member and the support arm of said second support member.

3. Machine as in claim 1, characterized in that said reference surface has a shape and orientation chosen from horizontal, vertical, inclined, flat, curved, undulating, or mixed.

4. Machine as in any claim 1, characterized in that it comprises elastic means associated with said gripping means, configured both to guarantee a stable grip by said gripping means, and also to cushion the impact of said gripping means during the transport of said plurality of components.

5. Machine as in claim 4, characterized in that said elastic means comprise a free end of said at least one support arm configured elastic and/or flexible.

6. Machine as in claim 5, characterized in that in the proximity of the free end of said at least one support arm there is a reduction in section, which makes said free end flexible and elastic.

7. Machine as in claim 1, characterized in that said gripping means also comprise an additional arm protruding from the respective support member and to which said support arm is transversely connected, said additional arm being shaped so that said support arm can keep said plurality of components raised with respect to the corresponding support member and/or support said plurality of components cantilevered with respect to said reference surface.

8. Machine as in claim 1, characterized in that said at least one support arm is provided at one end with a comb-type support, shaped so as to define a plurality of seatings aligned with each other, each of which are configured to simultaneously grip one component of said plurality of components.

9. Machine as in claim 1, characterized in that said support arm is provided at one end with a C-shaped support, configured to grip and support a nest or a tray provided with a plurality of seatings, each of which is configured to accommodate each component of said plurality of components.

10. Machine as in claim 1, characterized in that each support arm of said first and second support member is provided with a plurality of projecting elements, parallel and distanced from each other, so as to define a plurality of gripping seatings, when the projecting elements of the arm of the first support member are adjacent to the corresponding projecting elements of the arm of the second support member with one component of said plurality of components interposed in a grip.

11. Machine as in claim 1, characterized in that the support arm of said first support member is provided at one end with a rack support formed by a central elongated body from which a plurality of gripping segments branch out, while the support arm of said second support member is provided at one end with a forked support from which a plurality of other gripping segments branch out toward the inside of the fork, said rack support and said forked support being configured to cooperate with each other so as to create seatings to accommodate said plurality of components.

12. Machine as in claim 1, characterized in that said reference surface comprises a zone disposed vertically that has at least one aperture through which said plurality of containers, coming from a feed zone, pass in order to make them available to said gripping means so that they can be transported by the support members.

13. Machine as in claim 1, wherein said gripping means are respectively attached to said first and second support member in a removable manner.

14. Method to automatically transport a plurality of components to make a package from and to one or more working stations, by means of a machine having:
a reference surface in association with which said one or more working stations are disposed, and to which electric energizing means are associated, configured to selectively generate one or more magnetic fields;
at least a first and a second support member each provided with magnetic means which interact with said one or more magnetic fields, moving each of said first and second support member independently, without contact and without constraint in direction or path on said reference surface from and to said one or more working stations;
control means configured to energize selectively and in a coordinated manner said electric energizing means to cause the selective movement of each of said first and second support member from one point to another of said reference surface, characterized in that said method comprises at least:
a step of gripping said plurality of components, in which a support arm of said first support member cooperates with a support arm of said second support member, so as to temporarily support said plurality of components, at least a transport step, in which said plurality of components, supported by the respective support arms of said first and second support member, are transported from one point to another of said reference surface,
and a control step, in which said control means acquire information on the reciprocal positioning of said first and second support member and control the energizing of said electric energizing means in order to maintain an orientation and a predefined distance between the support arm of said first support member and the support arm of said second support member during the transport of said plurality of components.

15. Method as in claim 14, characterized in that it also comprises a step of preparing a nest or tray provided with a plurality of seatings, each of which is configured to accommodate each component of said plurality of components, in said gripping step said support arm of said first support member cooperating opposite with said support arm of said second support member in order to grip said nest lifting it from a support plane and to transport it, in said transport step, from and to one or more of said working stations.
